(19) United States
(12) Patent Application Publication
(10) Pub. No.: US 2016/0349862 A1
(43) Pub. Date: Dec. 1, 2016

(54) DIGITAL STYLUS WITH PUSH BUTTON AND DIAL

(71) Applicant: FIFTYTHREE, INC., New York, NY (US)

(72) Inventors: Jonathan Harris, Redmond, WA (US); Audrey Caroline Christine Louchart, Seattle, WA (US); Hauke Antony Gentzkow, Seattle, WA (US)

(73) Assignee: FIFTYTHREE, INC., New York, NY (US)

(21) Appl. No.: 14/721,910

(22) Filed: May 26, 2015

(51) Int. Cl. G06F 3/0354

(52) U.S. Cl. CPC G06F 3/03545

(57) ABSTRACT

A stylus may include input interfaces that provide a user with additional ways of manipulating an application on a user device beyond touching the stylus to a touch surface. The input interfaces may include a rotary encoder and/or a button. In some embodiments, a single component of the stylus may be usable as both a rotary encoder and a button. The stylus may include a controller able to detect user manipulation of the rotary encoder and/or the button. The controller may include or be communicatively coupled with a wireless interface. In response to user manipulation of the rotary encoder and/or the button, the controller may instruct the wireless interface to transmit an indication of the user manipulation to the user device.

### TECHNICAL FIELD

The present disclosure relates to styluses including one or more input interfaces.

### BRIEF DESCRIPTION OF THE DRAWINGS

FIGS. 1A-1D are perspective views of various ways a user may interact with an embodiment of a stylus with a rotary encoder.

FIG. 2 is a perspective view of an alternative embodiment of a stylus with a rotary encoder and a push button.

FIG. 3 is a perspective view of an alternative embodiment of a stylus with a rotary encoder and a push button.

FIG. 4 is a schematic diagram of a stylus that includes a rotary encoder and a button for receiving user input.

### DETAILED DESCRIPTION OF PREFERRED EMBODIMENTS

A stylus for interacting with a touch surface of a user device may include a body with a tip at a distal end of the body. The tip may simply be a same material as the body and/or may include a material selected specifically to be detected by the touch surface (e.g., to be detected by a capacitive touch surface, by a resistive touch surface, etc.). The user device may be any one of various portable electronic devices with a touch screen such as a tablet, phablet, laptop, smartphone, and the like.

The stylus may only provide input to the user device based on where the stylus is touched to the touch surface. Accordingly, for a user to manipulate settings, menus, controls, etc., the user may be required to interact directly with on-screen user interface (UI) elements and/or use another input device, such as a mouse, a keyboard, and/or the like. Repeated switching between input modalities may decrease the speed with which a user can input information and/or the user's satisfaction with the stylus. This may be particularly true for applications designed to have heavy stylus usage.

A stylus may include additional input interfaces besides a tip for a user to control UI elements of a user device. The stylus may include a push button and/or a rotary encoder for providing additional input to the user device. In some embodiments, the rotary encoder may also act as the push button. The push button may allow users to switch between UI elements, features, settings, menus, controls, etc., and the rotary encoder may allow for incremental adjustment to a particular UI element, feature, setting, menu, control, etc. For example, a drawing application may allow the user to change between drawing tools using the push button, and the rotary encoder that adjusts the line width, opacity of stroke, color, etc. for the selected tool. Alternatively, or in addition, the push button may be used to select whether the line width, opacity of stroke, color, etc. is adjusted by the rotary encoder. The user may be able to continue using the stylus to directly interact with a task while adjusting other aspects of the interface or feature set using the additional input interfaces of the stylus. The additional input interfaces may also, or instead, be used for peripheral input, such as environmental navigation or remote control of an application (e.g., slide show progression, web page scrolling, map zooming, etc.).

The stylus may include a controller coupled to the rotary encoder and/or the push button. The controller may be configured to detect whether the user has pressed the push button and/or rotated the rotary encoder. The controller may be communicatively coupled with a memory. The controller may also be coupled to a wireless interface, such as a radio (e.g., a transceiver, a transmitter, and/or the like). The radio may be coupled to an antenna. The radio may be communicatively coupled to the user device through any one of various wireless technologies such as Bluetooth, Zigbee, Wi-Fi, or other proprietary or non-proprietary protocols. The radio may be configured to communicate information about user interaction with the push button and/or rotary encoder. In some embodiments, a system on a chip may comprise the controller, the radio, the memory, the antenna, etc. The stylus may include a battery configured to provide power to the controller, the memory, the radio, the rotary encoder, the push button, and/or the like.

In some embodiments, the rotary encoder may be detented. The user may click the rotary encoder through one or a plurality of rotational positions. The user may be able to adjust the rotary encoder at small and/or gross scales. The controller may determine how many detents (e.g., clicks) the rotary encoder has been rotated through. The controller may communicate the number of clicks to the user device. In alternate embodiments, the rotary encoder may be detent-less and may smoothly rotate between positions. For example, the rotary encoder may include a quadrature encoder. The controller may determine a current rotational position of the rotary encoder and/or may determine a rotational displacement of the rotary encoder. The position and/or displacement may be detected and/or specified in increments of 1, 2, 5, 10, 15, 30, 45, 60, 90, 120, etc. degrees.

The push button may be separate from the rotary encoder, and/or the rotary encoder may include the push button. In an embodiment, the rotary encoder may act as a push button and may slide relative to the body of the stylus. The controller may determine when the rotary encoder has slid a predetermined distance and detect it as a press of the push button. For example, the rotary encoder may complete or disrupt a circuit when pressed the predetermined distance, and the controller may detect the completed or disrupted circuit. The rotary encoder may be configured to slide in a direction parallel to an axis of rotation and/or in a direction perpendicular to the axis of rotation. The controller may be configured to instruct the radio to transmit different indications to the user device depending on whether the push button is being pressed while the rotary encoder is rotated or the push button is not being pressed while the rotary encoder is rotated. The controller may also, or instead, instruct the radio to send an indication each time the push button is pressed.

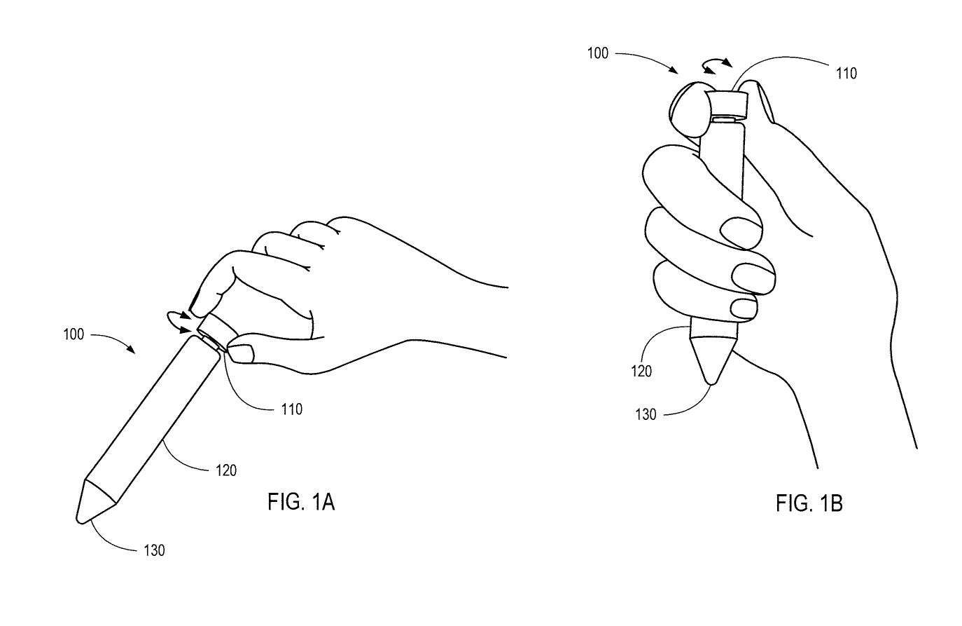

FIGS. 1A-1D are perspective views of various ways a user may interact with a rotary encoder 110 on a stylus 100. The stylus 100 may include a body 120 with a tip 130 at a distal end of the stylus 100. The rotary encoder 110 may be located at a proximal end of the body 120. The rotary encoder 110 may be rotated relative to the body 120 and around a rotational axis 122 to provide input to a user device (not shown) communicatively coupled to the stylus 100. The rotational axis 122 may correspond to a longitudinal axis of the stylus 100. The rotary encoder 110 may also or instead be displaced linearly relative to the body 120 in a direction parallel to an axis of rotation. In this manner, the rotary encoder 110 also functions as a push button.

In FIG. 1A, a user may rotate the rotary encoder 110 around a rotational axis 122 using a thumb and forefinger of the user's hand without gripping the stylus 100 with the palm of that hand. A second hand may be used to hold the body 120 of the stylus 100 stationary while the rotary encoder 110 is rotated.

In FIG. 1B, the user may rotate the rotary encoder 110 using a thumb and forefinger of the user's hand, and the palm and/or remaining fingers of that hand may be used to hold the body 120 stationary while the rotary encoder 110 is rotated.

In FIG. 1C, the user's thumb may be used to press the rotary encoder 110 in a direction along the rotational axis 122 or parallel to the rotational axis 122, and the remaining fingers and/or palm of that hand may be used to hold the body 120 stationary. After being pressed, the rotary encoder 110 may be biased to return to its original position along the rotational axis 122.

In FIG. 1D, the user may rotate the rotary encoder 110 using only a thumb, and the remaining fingers and/or palm of that hand may be used to hold the body 120 stationary while the rotary encoder 110 is rotated.

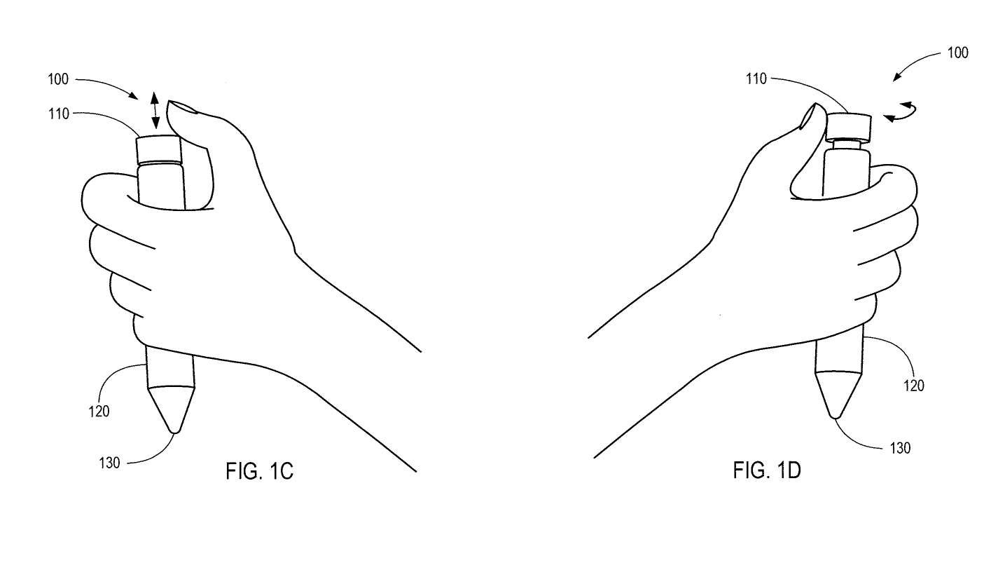

FIG. 2 illustrates an alternative embodiment of a stylus 200 with a push button 202 disposed on the rotary encoder 204. The rotary encoder 204 may not move linearly relative to the body 206. As shown, the push button 202 is disposed on the proximate end of the stylus 200 and may be displaced linearly relative to the body 206 and in a direction parallel to an axis of rotation of the rotary encoder 204. As can be appreciated, operation of the push button 202 or rotary encoder 204 generates instruction through a wireless interface to the user device.

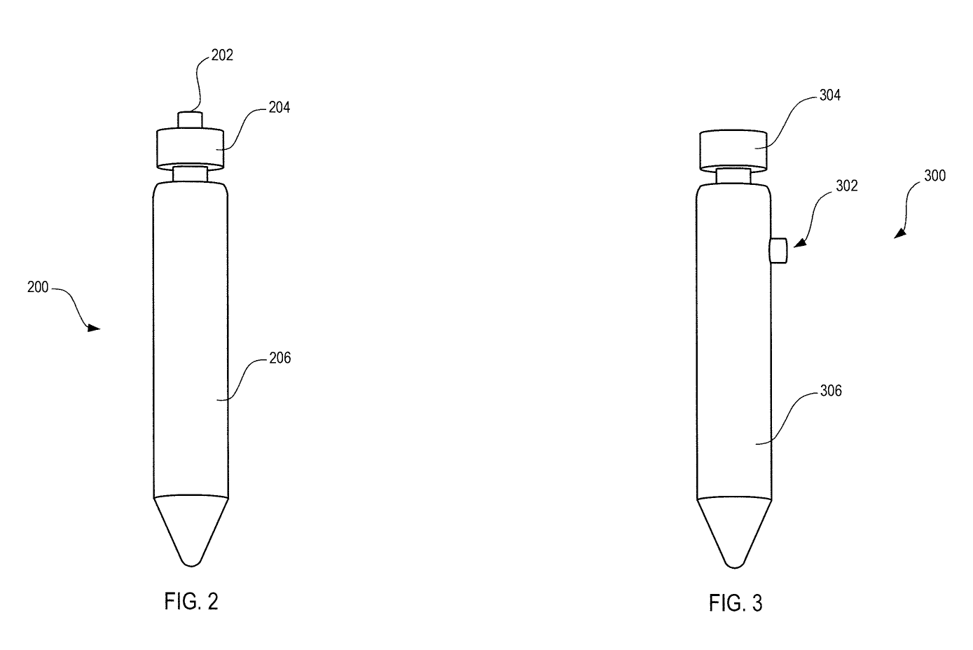

FIG. 3 illustrates an alternative embodiment of a stylus 300 with a push button 302 disposed separate from the rotary encoder 304. The push button 302 is located directly on the surface of the body 306 based on ergonomic preferences. The stylus 300 may also include multiple push buttons to increase options for the UI.

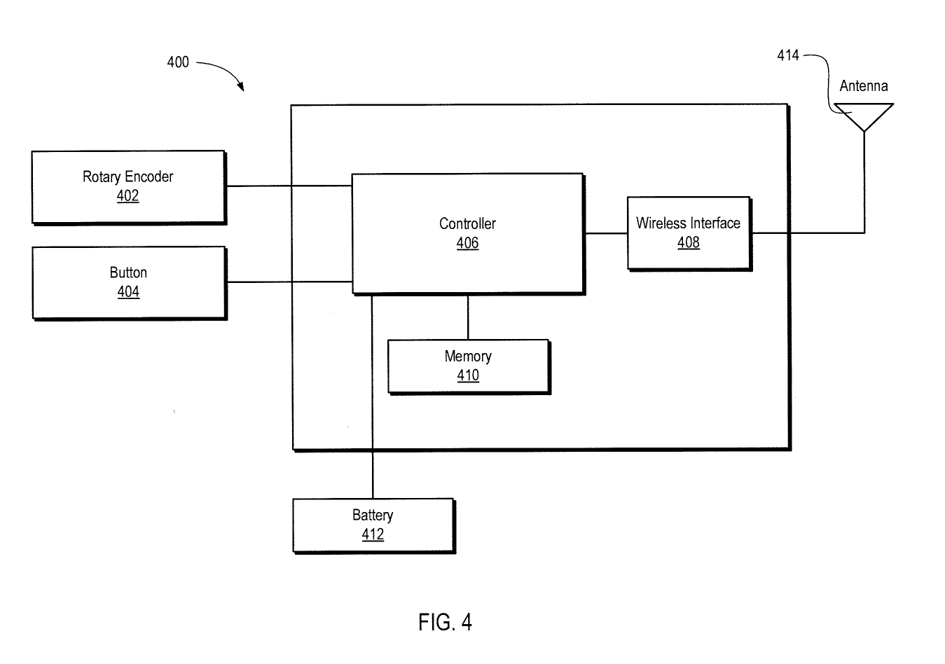

FIG. 4 is a schematic diagram of a stylus 400 that includes a rotary encoder 402 and a push button 404 for receiving user input. Although depicted as distinct elements in the figure, the rotary encoder 402 and the push button 404 may share components in some embodiments. For example, electrical contacts for registering rotation of the rotary encoder 402 and/or pressing of the push button 404 may be distinct such as in FIGS. 2 and 3. Alternatively, the rotary encoder 402 and/or the push button 404 may be included in the same body manipulated by the user, such as in FIGS. 1A-D. The rotary encoder 402 and/or the push button 404 may be electrically coupled to a controller 406. The rotary encoder 402 and/or the push button 404 may complete and/or disrupt one or more circuits when manipulated, and the controller 406 may be electrically coupled to the one or more circuits completed or disrupted.

The controller 406 may be configured to determine a position and/or displacement of the rotary encoder 402 and/or the push button 404 based on the one or more circuits. Alternatively, or in addition, the controller 406 may determine whether the push button 404 has been pressed beyond a predetermined threshold by the user. The controller 406 may be communicatively coupled to a wireless interface or radio 408, which may be connected to an antenna 214. The controller 406 may produce an indication of an input received by the rotary encoder 402 and/or the push button 404. The controller 406 may instruct the wireless interface 408 to transmit the indication to the user device. The indication may include whether the push button 404 was/is currently being pressed, a rotational displacement of the rotary encoder 402, whether the push button 404 was pressed while the rotary encoder 402 was rotated, and/or the like.

The controller 406 may periodically instruct the wireless interface 408 to transmit an indication of the status of the rotary encoder 402 and/or the push button 404, and/or the controller 406 may instruct the wireless interface 408 to transmit an indication of the status of the rotary encoder 402 and/or the button 404 in response to receiving an input via the rotary encoder 402 and/or the push button 404. In some embodiments, the controller 406 may transmit a current state of the rotary encoder 402 and/or the push button 404, and the user device is responsible for determining whether the current state is different from a previous state. Alternatively, or in addition, the controller 406 may determine whether the current state is different from the previous state and may transmit an indication of how the state has changed.

The controller 406 may be communicatively coupled to a battery 412. The battery 412 may be configured to provide power to the controller 406. In some embodiments, the controller 406 may provide power to other components, such as the rotary encoder 402, the push button 404, the wireless interface 408, and/or the like. Alternatively, or in addition, the battery 412 may provide power directly to components besides the controller 406 (e.g., the rotary encoder 402, the push button 404, the wireless interface 408, etc.). The controller 406 may be communicatively coupled to a memory 410. The memory 410 may store instructions for the controller 406 and/or may store data for the controller 406, such as a current state of the rotary encoder 402 and/or the push button 404.

Embodiments may include various steps, which may be embodied in machine-executable instructions to be executed by a computer system. A computer system, such as the disclosed user device, includes one or more general-purpose or special-purpose computers (or other electronic devices). The computer system may include hardware components that include specific logic for performing the steps or may include a combination of hardware, software, and/or firmware.

Embodiments may also be provided as a computer program product including a computer-readable medium having stored thereon instructions that may be used to program a computer system or other electronic device to perform the processes described herein. The computer-readable medium may include, but is not limited to: hard drives, floppy diskettes, optical disks, CD ROMs, DVD ROMs, ROMs, RAMs, EPROMs, EEPROMs, magnetic or optical cards, solid-state memory devices, or other types of media/computer-readable media suitable for storing electronic instructions.

Computer systems and the computers in a computer system may be connected via a network. Suitable networks for configuration and/or use as described herein include one or more local area networks, wide area networks, metropolitan area networks, and/or “Internet” or IP networks, such as the World Wide Web, a private Internet, a secure Internet, a value-added network, a virtual private network, an extranet, an intranet, or even standalone machines that communicate with other machines by physical transport of media (a so-called “sneakernet”). In particular, a suitable network may be formed from parts or entireties of two or more other networks, including networks using disparate hardware and network communication technologies.

One suitable network includes a server and several clients; other suitable networks may contain other combinations of servers, clients, and/or peer-to-peer nodes, and a given computer system may function both as a client and as a server. Each network includes at least two computers or computer systems, such as the server and/or clients. A computer system may include a workstation, laptop computer, disconnectable mobile computer, server, mainframe, cluster, so-called “network computer” or “thin client,” tablet, smart phone, personal digital assistant or other hand-held computing device, “smart” consumer electronics device or appliance, medical device, or a combination thereof.

The network may include communications or networking software, such as the software available from Novell, Microsoft, Artisoft, and other vendors, and may operate using TCP/IP, SPX, IPX, and other protocols over twisted pair, coaxial, or optical fiber cables, telephone lines, radio waves, satellites, microwave relays, modulated AC power lines, physical media transfer, and/or other data transmission “wires” and/or wireless protocols known to those of skill in the art. The network may encompass smaller networks and/or be connectable to other networks through a gateway or similar mechanism.

Each computer system includes at least a processor and a memory; computer systems may also include various input devices and/or output devices. The processor may include a general purpose device, such as an Intel®, AMD®, or other “off-the-shelf” microprocessor. The processor may include a special purpose processing device, such as an ASIC, SoC, SiP, FPGA, PAL, PLA, FPLA, PLD, or other customized or programmable device. The memory may include static RAM, dynamic RAM, flash memory, one or more flip-flops, ROM, CD-ROM, disk, tape, magnetic, optical, or other computer storage medium. The input device(s) may include a keyboard, mouse, touch screen, light pen, tablet, microphone, sensor, or other hardware with accompanying firmware and/or software. The output device(s) may include a monitor or other display, touch screen, printer, speech or text synthesizer, switch, signal line, or other hardware with accompanying firmware and/or software.

The computer systems may be capable of using a floppy drive, tape drive, optical drive, magneto-optical drive, or other means to read a storage medium. A suitable storage medium includes a magnetic, optical, or other computer-readable storage device having a specific physical configuration. Suitable storage devices include floppy disks, hard disks, tape, CD-ROMs, DVDs, PROMs, random access memory, flash memory, and other computer system storage devices. The physical configuration represents data and instructions that cause the computer system to operate in a specific and predefined manner as described herein.

Suitable software to assist in implementing the invention is readily provided by those of skill in the pertinent art(s) using the teachings presented here and programming languages and tools, such as Java, Pascal, C++, C, database languages, APIs, SDKs, assembly, firmware, microcode, and/or other languages and tools. Suitable signal formats may be embodied in analog or digital form, with or without error detection and/or correction bits, packet headers, network addresses in a specific format, and/or other supporting data readily provided by those of skill in the pertinent art(s).

Several aspects of the embodiments described will be illustrated as software modules or components. As used herein, a software module or component may include any type of computer instruction or computer executable code located within a memory device. A software module may, for instance, include one or more physical or logical blocks of computer instructions, which may be organized as a routine, program, object, component, data structure, etc., that perform one or more tasks or implement particular abstract data types.

In certain embodiments, a particular software module may include disparate instructions stored in different locations of a memory device, different memory devices, or different computers, which together implement the described functionality of the module. Indeed, a module may include a single instruction or many instructions, and may be distributed over several different code segments, among different programs, and across several memory devices. Some embodiments may be practiced in a distributed computing environment where tasks are performed by a remote processing device linked through a communications network. In a distributed computing environment, software modules may be located in local and/or remote memory storage devices. In addition, data being tied or rendered together in a database record may be resident in the same memory device, or across several memory devices, and may be linked together in fields of a record in a database across a network.

Much of the infrastructure that can be used according to the present invention is already available, such as: general purpose computers, computer programming tools and techniques, computer networks and networking technologies, digital storage media, authentication, access control, and other security tools and techniques provided by public keys, encryption, firewalls, and/or other means.

Those having skill in the art will appreciate that many changes may be made to the details of the above-described embodiments without departing from the underlying principles of the disclosure. The scope of the present application should, therefore, be determined only by the following claims.

1. A stylus to interface with a user device, the stylus comprising:
a body including a tip at a distal end of the body;
a rotary encoder coupled to a proximate end of the body and configured to rotate about a rotational axis;
a controller in electrical communication with the rotary encoder and configured to determine a rotational displacement of the rotary encoder; and
a wireless interface in electrical communication with the controller and configured to transmit a signal indicative of the rotational displacement.

2. The stylus of claim 1, wherein the controller is configured to generate a signal to operate an application on the user device based on the rotational displacement of the rotary encoder.

3. The stylus of claim 2, wherein the controller is configured to generate a signal to change an option of a drawing application on the user device based on the rotational displacement of the rotary encoder.

4. The stylus of claim 1, wherein the rotary encoder is configured to move along the rotational axis in response to applied force, wherein the controller is configured to determine movement of the rotary encoder along the rotational axis, and wherein the wireless interface is configured to transmit to the user device a signal indicative of movement of the rotary encoder.

5. The stylus of claim 4, wherein the controller is configured to generate a signal to operate an application on the user device based on movement of the rotary encoder along the rotational axis.

6. The stylus of claim 1, further comprising a push button disposed on the rotary encoder and in electrical communication with the controller, wherein the controller is configured to determine when the push button has been pressed, and wherein the wireless interface is configured to transmit to the user device a signal indicative of the push button being pressed.

7. The stylus of claim 1, further comprising a push button disposed on the body and in electrical communication with the controller, wherein the controller is configured to determine when the push button has been pressed, and wherein the wireless interface is configured to transmit to the user device a signal indicative of the push button being pressed.

8. The stylus of claim 1, further comprising a memory in electrical communication with the controller and storing instructions for the controller.

9. The stylus of claim 8, wherein the memory is configured to store data representative of the current state of position for the rotary encoder.

10. The stylus of claim 1, further comprising an antenna in electrical communication with the wireless interface.

11. The stylus of claim 1, wherein the rotary encoder is configured with a plurality of detents and is configured to rotate through the plurality of detents.

12. A stylus to provide contact and wireless interface with a user device, the stylus comprising:
a body including a tip at a distal end of the body, the tip configured to contact a touch screen on the user device;
a rotary encoder coupled to a proximate end of the body and configured to rotate about a rotational axis and further configured to move along the rotational axis;
a controller in electrical communication with the rotary encoder and configured to determine a rotational displacement of the rotary encoder and to determine a displacement of the rotary encoder along the rotational axis; and
a wireless interface in electrical communication with the controller and configured to communicate with an application on the user device and transmit a signal to the user device indicative of movement of the rotary encoder.

13. The stylus of claim 12, wherein the controller is configured to generate a signal to operate the application on the user device based on a rotational displacement of the rotary encoder.

14. The stylus of claim 13, wherein the controller is configured to generate a signal to change an option on a drawing application on the user device based on a rotational displacement of the rotary encoder.

15. The stylus of claim 12, wherein the controller is configured to generate a signal to operate the application on the user device based on movement of the rotary encoder along the rotational axis.

16. The stylus of claim 12, further comprising a memory in electrical communication with the controller and storing computer readable instructions for the controller.

17. The stylus of claim 16, wherein the memory is configured to store data representative of the current state of position for the rotary encoder.

18. The stylus of claim 12, further comprising an antenna in electrical communication with the wireless interface.

19. The stylus of claim 12, wherein the rotary encoder is configured with a plurality of detents and is configured to rotate through the plurality of detents.
